(19) United States
(12) Patent Application Publication
(10) Pub. No.: US 2025/0279694 A1
(43) Pub. Date: Sep. 4, 2025

(54) MOTOR VIBRATION DAMPING STRUCTURE FOR BLOW DRYER AND BLOW DRYER ITSELF

(71) Applicant: SHENZHEN PETABOO TECHNOLOGY CO., LTD., SHENZHEN (CN)

(72) Inventor: BOCHAO XU, SHENZHEN (CN)

(21) Appl. No.: 19/013,162

(22) Filed: Jan. 8, 2025

(30) Foreign Application Priority Data
Mar. 4, 2024 (CN) 202420413433.9

(51) Int. Cl. H02K 5/24; H02K 7/14; H02K 9/02

(52) U.S. Cl. CPC H02K 5/24; H02K 7/14; H02K 9/02

(57) ABSTRACT

The present disclosure discloses a motor vibration-damping structure for a water blower, including a main body, wherein the main body is provided with a motor chamber, and the motor chamber contains a motor. The main body also includes a first installation column, and the side of the motor chamber extends out to form a first mounting part. The motor chamber is fixed to the first installation column through its first mounting part, such that the first installation column serves as the connection support to connect the motor chamber to the main body. Furthermore, a first flexible damping component is arranged between the first mounting part and the first installation column to allow for a flexible connection between the motor chamber and the first installation column. The present disclosure also provides a water blower. Through the above structural arrangement, the motor's vibration-damping effect is effectively enhanced.

### TECHNICAL FIELD

The present disclosure relates to the field of pet supplies, specifically to a motor vibration damping structure for a blow dryer and the blow dryer itself.

### BACKGROUND

A blow dryer is a new product that has emerged in recent years, used to dry pets' fur after bathing. With continuous product iteration and updates, blow dryers are trending toward a more compact design. In existing technology, due to the compact design of blow dryers, on one hand, the vibration generated by the motor during operation is more easily transmitted outward; on the other hand, the compact design also brings the blow dryer closer to the user, making it easier for motor vibrations to be transmitted to the user. As a result, in existing blow dryers, motor vibrations are more readily transmitted to the user, which negatively impacts the user experience.

### SUMMARY

In order to overcome the disadvantages of the prior art, the present disclosure provides a motor vibration damping structure for a blow dryer and the blow dryer itself.

The technical solution adopted by the present disclosure to solve its technical problem is as follows:

The present disclosure provides a motor vibration damping structure for a blow dryer, which includes a main body, a motor chamber arranged within the main body, a motor arranged in the motor chamber, and a first installation column inside the main body.

A first installation part extends from the side of the motor chamber, and the motor chamber is fixed to the first installation column by its first installation part. This allows the first installation column to serve as a connection point, linking the motor chamber to the main body.

Additionally, a first flexible damping element is placed between the first installation part and the first installation column to provide a flexible connection between the motor chamber and the first installation column.

The front of the motor chamber is provided with a heating chamber. The side of the heating chamber extends out a second installation part, and accordingly, a second installation column is arranged inside the main body. The heating chamber is fixed to the second installation column by its second installation part, so that the second installation column serves as a connection point, linking the heating chamber to the main body.

A second flexible damping element is placed between the second installation part and the second installation column to provide a flexible connection between the heating chamber and the second installation column.

There are two first installation parts, symmetrically arranged on both sides of the motor chamber. Accordingly, there are two first installation columns, symmetrically arranged on both sides of the motor chamber. The second installation parts are four in number, symmetrically arranged on both sides of the heating chamber, and there are four second installation columns, symmetrically arranged on both sides of the heating chamber.

The first installation part has a first installation hole, and the first flexible damping element is located inside the first installation hole. The first flexible damping element is sleeve-shaped and is sleeved onto the first installation column. The second installation part has a second installation hole, and the second flexible damping element is located inside the second installation hole.

The second flexible damping element is also sleeve-shaped and is sleeved onto the second installation column.

The motor chamber is equipped with a first air inlet and a first air outlet, with the first air inlet and the first air outlet arranged opposite each other. The motor chamber contains a motor, and the front of the motor is fitted with a first flexible damping sleeve, while the rear of the motor is fitted with a second flexible damping sleeve. Both the first and second flexible damping sleeves closely fit the inner wall of the motor chamber.

The first flexible damping sleeve is provided with a front clearance hole, which corresponds to the first air outlet, and the second flexible damping sleeve is provided with a rear clearance hole, which corresponds to the first air inlet.

The first flexible damping sleeve extends from the front of the motor towards the center of the motor, and the second flexible damping sleeve extends from the rear of the motor towards the center of the motor.

The first flexible damping sleeve includes an inner sleeve and an outer sleeve, with the inner sleeve sleeved onto the front end of the motor. The front end of the inner sleeve forms the front clearance hole, and there is an installation groove between the inner and outer sleeves. The first flexible damping sleeve is sleeved onto the sidewall of the first air outlet by its installation groove.

The first flexible damping sleeve also includes a connecting part, which connects the inner sleeve and the outer sleeve, forming the bottom wall of the installation groove. The heating chamber presses the connecting part against the sidewall of the first air outlet.

The heating chamber contains a heating element and has a second air outlet. The first air outlet of the motor chamber is connected to the second air outlet through the heating chamber.

The rear end of the motor chamber extends outward toward the center, forming a damping stop plate. The first air inlet is arranged on the damping stop plate, and correspondingly, the rear end of the second flexible damping sleeve extends out a damping part between the damping stop plate and the rear end of the motor. The rear clearance hole is located on the damping part.

The damping part extends towards the first air inlet, forming a clamping part that clamps onto the first air inlet.

The rear end of the motor chamber extends into a circuit board chamber, which contains a circuit board. The rear end of the circuit board chamber has a second air inlet, which connects to the first air inlet of the motor chamber through the circuit board chamber.

The first and second flexible damping sleeves are made of silicone, and the motor is a brushless motor.

The present disclosure further provides a blow dryer, which includes the motor vibration damping structure described above.

Through the above structure, the motor chamber is fixed to the first installation column by its first installation part, allowing the first installation column to serve as a connection point, linking the motor chamber to the main body.

This creates a stable connection structure, ensuring the stability of the motor chamber's connection and reducing motor vibrations. Additionally, the first flexible damping element between the first installation part and the first installation column provides a flexible connection between the motor chamber and the first installation column, effectively slowing the transmission of motor vibrations and thereby enhancing the damping effect.

In summary, the present disclosure features a simple and stable structure, excellent damping performance, and an improved user experience.

### BRIEF DESCRIPTION OF THE DRAWINGS

In order to clearly illustrate the technical solutions in the embodiments of the present disclosure, the following provides a brief description of the drawings used in the embodiment description. The drawings described below are only some embodiments of the present disclosure. For those skilled in the art, without inventive effort, additional drawings can be obtained based on these drawings.

The present disclosure will be further explained in conjunction with the following drawings and embodiments.

FIG. 1 is a schematic structural diagram of the present disclosure.

FIG. 2 is a schematic diagram of the internal structure of the present disclosure.

FIG. 3 is a cross-sectional view taken transversely through the motor chamber of the present disclosure.

FIG. 4 is an enlarged view of section B in FIG. 3.

FIG. 5 is a cross-sectional view taken transversely through the heating chamber of the present disclosure.

FIG. 6 is an enlarged view of section C in FIG. 5.

FIG. 7 is a longitudinal cross-sectional view of the present disclosure.

FIG. 8 is an enlarged view of section A in FIG. 7.

### DETAILED DESCRIPTION OF THE EMBODIMENTS

### Embodiment 1

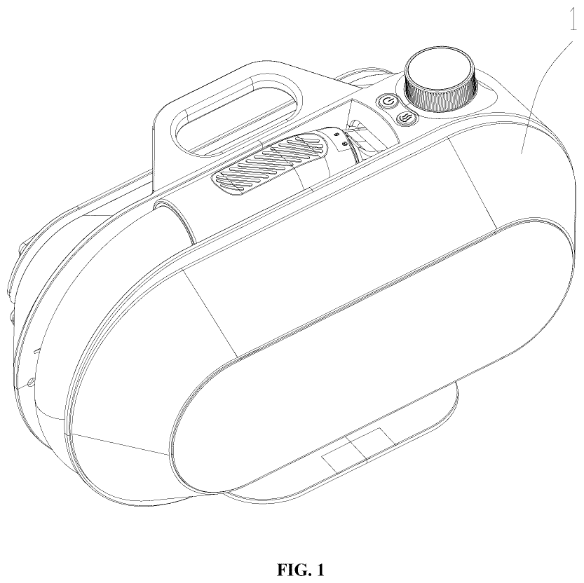

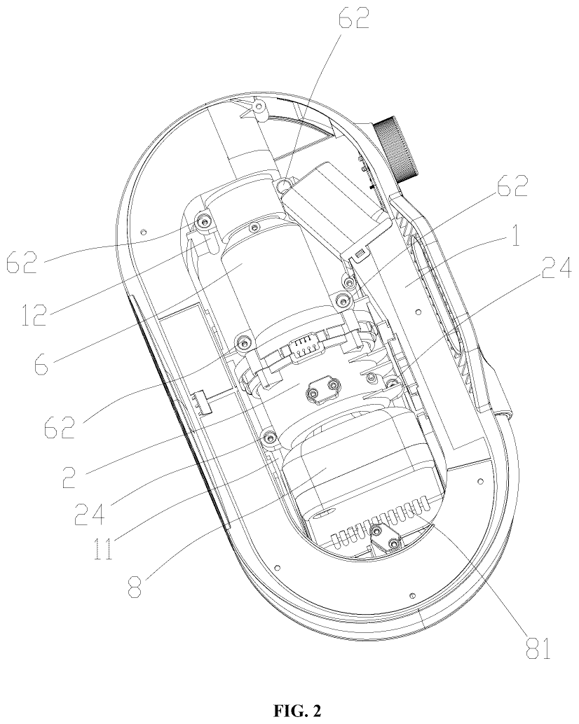

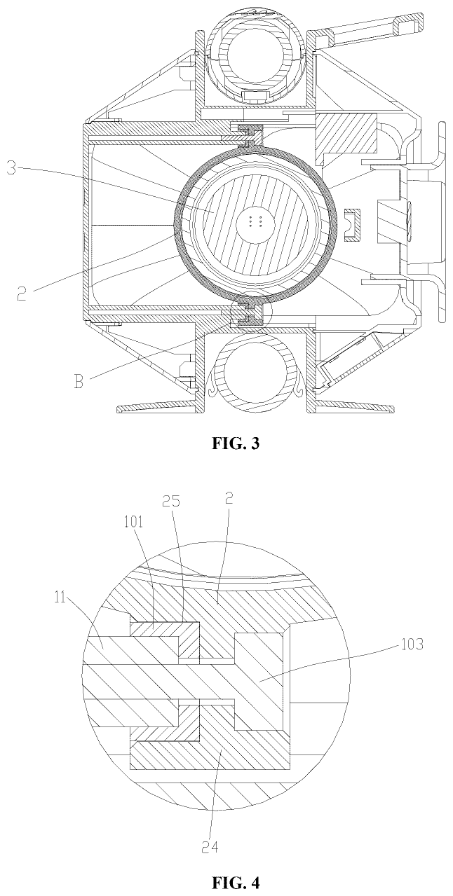

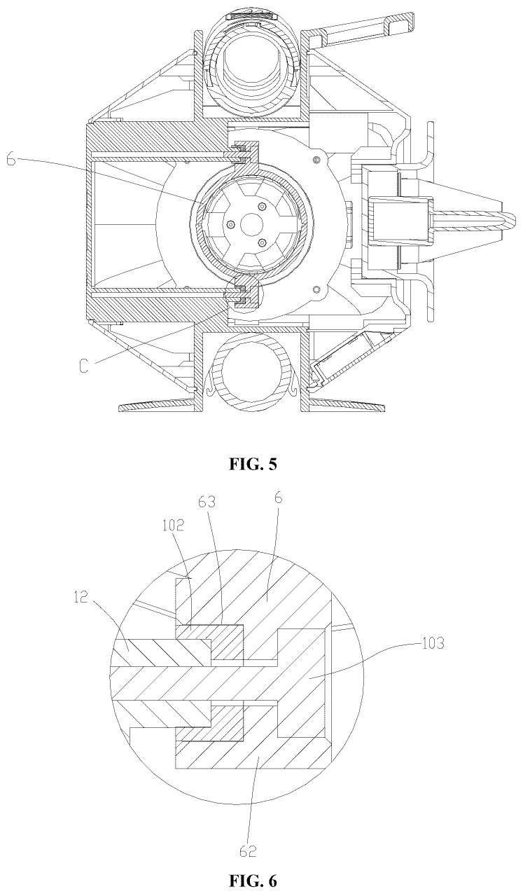

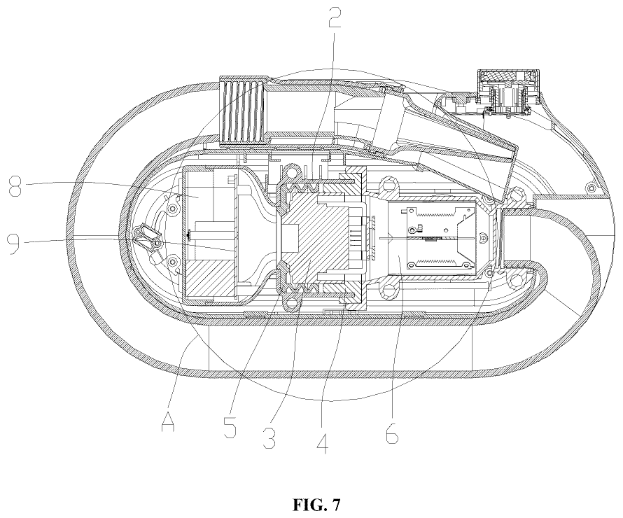

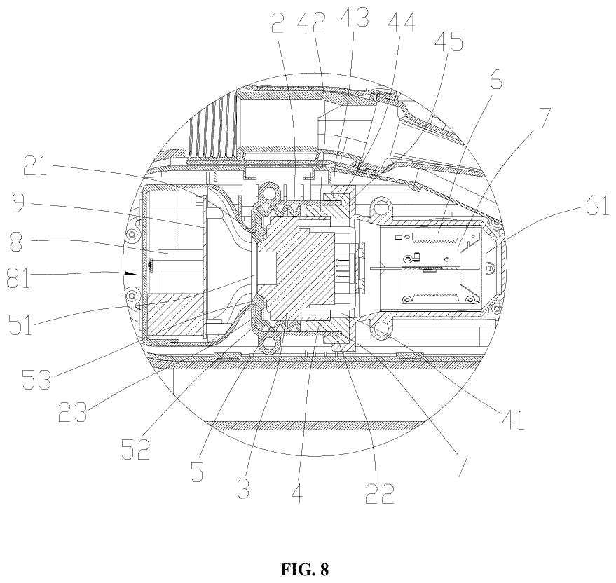

With reference to FIGS. 1 to 8, a motor vibration-damping structure for a blower includes a main body 1. The main body 1 has a motor chamber 2, within which a motor 3 is arranged. The main body 1 also includes a first mounting pillar 11. The side of the motor chamber 2 extends out to form a first mounting portion 24. The motor chamber 2 is fixed to the first mounting pillar 11 via the first mounting portion 24, with the first mounting pillar 11 serving as a connection support to attach the motor chamber 2 to the main body 1. Additionally, a first flexible damping element 101 is arranged between the first mounting portion 24 and the first mounting pillar 11, providing a flexible connection between the motor chamber 2 and the first mounting pillar 11.

Through this structural configuration, the motor chamber is fixed to the first mounting pillar, using the first mounting pillar as a connection support to attach the motor chamber to the main body, forming a stable connection structure that ensures the stability of the motor chamber connection and reduces vibration from the motor. Furthermore, the first flexible damping element between the first mounting portion and the first mounting pillar provides a flexible connection, effectively damping the transmission of vibrations from the motor, thereby enhancing the motor's vibration damping effect.

In summary, the product of the present disclosure has a simple and stable structure with good vibration-damping performance, improving the user's operating experience.

In this embodiment, the front of the motor chamber 2 is equipped with a heating chamber 6. The side of the heating chamber 6 extends to form a second mounting portion 62. Correspondingly, the main body 1 also has a second mounting pillar 12. The heating chamber 6 is fixed to the second mounting pillar 12 via the second mounting portion 62, with the second mounting pillar 12 serving as a connection support to attach the heating chamber 6 to the main body 1. A second flexible damping element 102 is arranged between the second mounting portion 62 and the second mounting pillar 12, providing a flexible connection between the heating chamber 6 and the second mounting pillar 12.

With this configuration, the heating chamber is fixed to the second mounting pillar, using the second mounting pillar as a connection support to attach the heating chamber to the main body, forming a stable connection structure that ensures the stability of the heating chamber connection. Additionally, the second flexible damping element between the second mounting portion and the second mounting pillar provides a flexible connection, effectively damping the transmission of vibrations from the heating chamber, thereby improving the overall vibration-damping effect.

The motor chamber and the heating chamber are connected as a unit, and through the first and second mounting pillars, a comprehensive vibration-damping structure is formed for the motor, effectively improving the motor's vibration-damping performance. The motor chamber and heating chamber can be fixed using screws.

Furthermore, the first mounting portion 24 is provided with two units, symmetrically arranged on both sides of the motor chamber 2. Similarly, the first mounting pillars 11 are arranged symmetrically on both sides of the motor chamber 2. The second mounting portion 62 consists of four units, symmetrically arranged on both sides of the heating chamber 6, with the second mounting pillars 12 arranged symmetrically on both sides of the heating chamber 6. This arrangement forms a six-point vibration-damping structure, which effectively enhances vibration-damping performance.

Specifically, the mounting portions can be symmetrically arranged on the top and bottom of the motor chamber and heating chamber, creating a top connection and bottom support structure to enhance the stability of the overall structure.

Specifically, the first mounting portion 24 is provided with a first mounting hole 25. The first flexible damping element 101 is arranged inside the first mounting hole 25, and the first flexible damping element 101 has a sleeve shape to fit over the first mounting pillar 11. Similarly, the second mounting portion 62 is provided with a second mounting hole 63, and the second flexible damping element 102 is arranged inside the second mounting hole 63. The second flexible damping element 102 also has a sleeve shape to fit over the second mounting pillar 12.

This design facilitates assembly and ensures the damping effect is optimized. The first and second flexible damping elements are both sleeve-shaped, further enhancing the damping effect. During installation, screws 103 can pass through the first mounting portion, the first flexible damping element, and the first mounting pillar to secure the three components together. Similarly, screws 103 can pass through the second mounting portion, the second flexible damping element, and the second mounting pillar to fix these components.

In this embodiment, the motor chamber 2 is provided with a first air inlet 21 and a first air outlet 22, which are oppositely arranged. The motor chamber 2 houses the motor 3, with the front end of the motor 3 fitted with a first flexible damping sleeve 4 and the rear end fitted with a second flexible damping sleeve 5. Both the first and second flexible damping sleeves 4 and 5 fit against the inner wall of the motor chamber 2.

The first flexible damping sleeve 4 has a front-end clearance hole 41, which corresponds to the first air outlet 22, and the second flexible damping sleeve 5 has a rear end clearance hole 51, which corresponds to the first air inlet 21.

With the above-mentioned structural configuration, during use, the motor operates to drive airflow from the first air inlet of the motor chamber to the first air outlet. Furthermore, because the front end of the motor is fitted with a first flexible damping sleeve and the rear end is fitted with a second flexible damping sleeve, both of which are in close contact with the inner wall of the motor chamber, the motor and the motor chamber can be tightly coupled through the first and second flexible damping sleeves.

This results in a more compact motor mounting structure, achieving dual damping at both the front and rear ends of the motor, effectively improving the motor's vibration-damping performance, and consequently enhancing the user's operating experience. Additionally, the first flexible damping sleeve is provided with a front clearance hole, and the second flexible damping sleeve is provided with a rear clearance hole to ensure that the damping elements do not interfere with the airflow.

In this embodiment, the first flexible damping sleeve 4 extends from the front of the motor 3 towards the center of the motor 3, and the second flexible damping sleeve 5 extends from the rear of the motor 3 towards the center of the motor 3.

This arrangement improves the fit of the first flexible damping sleeve at the front of the motor and the second flexible damping sleeve at the rear of the motor, making the motor's vibration-damping structure more compact and providing an optimized dual-damping effect from the front end to the center and from the rear end to the center. Both the first flexible damping sleeve 4 and the second flexible damping sleeve 5 are made of silicone.

Furthermore, the first and second flexible damping sleeves can be designed with a pleated structure to both support the motor's heat dissipation and improve elasticity, effectively enhancing the damping effect.

In this embodiment, the first flexible damping sleeve 4 includes an inner sleeve 42 and an outer sleeve 43. The inner sleeve 42 is fitted over the front end of the motor 3, with the front end of the inner sleeve 42 forming the front clearance hole 41. An installation groove 44 is arranged between the inner sleeve 42 and the outer sleeve 43, and the first flexible damping sleeve 4 is fitted onto the sidewall of the first air outlet 22 through this installation groove 44, simplifying the structure and facilitating installation.

Additionally, the first flexible damping sleeve 4 includes a connecting part 45, which connects the inner sleeve 42 and the outer sleeve 43, forming the bottom wall of the installation groove 44. A heating chamber 6 is also provided in the main body, and the heating chamber 6 presses the connecting part 45 tightly against the sidewall of the first air outlet 22, creating a simple structure that is easy to install.

In this embodiment, the heating chamber 6 is equipped with a heating element 7 and has a second air outlet 61. The first air outlet 22 of the motor chamber 2 is connected to the second air outlet 61 through the heating chamber 6, allowing the blower to blow hot air. This structure is simple and convenient to use.

The rear end of the motor chamber 2 extends outward and towards the center, forming a vibration stop plate 23. The first air inlet 21 is arranged on the vibration stop plate 23, and the rear end of the second flexible damping sleeve 5 extends between the vibration stop plate 23 and the rear end of the motor 3 to form a damping part 52. The rear clearance hole 51 is arranged on the damping part 52.

This configuration allows the second flexible damping sleeve to form a covering around the rear end of the motor, further enhancing the vibration-damping effect on the motor.

Furthermore, the damping part 52 extends towards the first air inlet 21 to form a clamping part 53, which is clamped to the first air inlet 21, making the connection between the second flexible damping sleeve and the motor chamber more compact and further improving the vibration-damping effect.

In this embodiment, the rear end of the motor chamber 2 extends to form a circuit board chamber 8. The circuit board chamber 8 houses a circuit board 9, and the rear end of the circuit board chamber 8 is provided with a second air inlet 81.

The second air inlet 81 communicates with the first air inlet 21 of the motor chamber 2 through the circuit board chamber 8. This arrangement creates a continuous flow channel inside the blower, connecting the second air inlet, the circuit board chamber, the first air inlet, the motor chamber, the first air outlet, the heating chamber, and the second air outlet, forming a simple and convenient structure for assembly.

Furthermore, both the circuit board and the motor are within the flow channel, allowing for effective heat dissipation for both components, resulting in a well-designed and clever structure.

In this embodiment, the motor 3 is a brushless motor, which effectively reduces motor noise and further enhances the user experience of the product.

### Embodiment 2

Referring to FIGS. 1 to 8, a water blower is provided, which includes the motor vibration-damping structure of the water blower described above.

In this embodiment, the water blower includes the motor vibration-damping structure as described above. In the motor vibration-damping structure of the water blower, the motor chamber is fixed to the first installation column through its first mounting part, such that the first installation column serves as the connection support to connect the motor chamber to the main body, forming a stable supporting structure that ensures the stability of the motor chamber support, thereby reducing motor vibrations.

Additionally, a first flexible damping component is arranged between the first mounting part and the first installation column, enabling the motor chamber to be flexibly connected to the first installation column, effectively dampening the transmission of motor vibrations to the outside, and thus significantly enhancing the motor's vibration-damping effect.

In summary, the present disclosure's product structure is simple, stable, and provides excellent vibration damping, effectively enhancing the user's operating experience.

The above provides one or more embodiments in conjunction with the specific details and is not intended to limit the practical application of the present disclosure to only these descriptions.

Any methods, structures, or technical derivations or substitutions that are similar or identical to the present disclosure's concept are considered within the scope of protection of this present disclosure.

What is claimed is:

1. A motor vibration damping structure for a blow dryer comprising a main body (1), within which a motor chamber (2) is arranged, the motor chamber (2) contains a motor (3), wherein the main body (1) is provided with a first mounting post (11), and the side of the motor chamber (2) extends out into a first mounting section (24), the motor chamber (2) is fixed to the first mounting post (11) via the first mounting section (24), such that the first mounting post (11) acts as a connection pivot, linking the motor chamber (2) to the main body (1), a first flexible damping component (101) is arranged between the first mounting section (24) and the first mounting post (11), enabling a flexible connection between the motor chamber (2) and the first mounting post (11).

2. The motor vibration damping structure for the blow dryer according to claim 1, wherein the front end of the motor chamber (2) is provided with a heating chamber (6), and the side of the heating chamber (6) extends out into a second mounting section (62), correspondingly, the main body (1) also includes a second mounting post (12), the heating chamber (6) is fixed to the second mounting post (12) via the second mounting section (62), such that the second mounting post (12) serves as a connection pivot to link the heating chamber (6) to the main body (1), a second flexible damping component (102) is arranged between the second mounting section (62) and the second mounting post (12), enabling a flexible connection between the heating chamber (6) and the second mounting post (12).

3. The motor vibration damping structure for the blow dryer according to claim 2, wherein the number of first mounting sections (24) is two, and the two first mounting sections (24) are symmetrically arranged on both sides of the motor chamber (2), the number of first mounting posts (11) is also two, and the two first mounting posts (11) are symmetrically arranged on both sides of the motor chamber (2). The number of second mounting sections (62) is four, and the four second mounting sections (62) are symmetrically arranged on both sides of the heating chamber (6), correspondingly, the number of second mounting posts (12) is also four, and the four second mounting posts (12) are symmetrically arranged on both sides of the heating chamber (6).

4. The motor vibration damping structure for the blow dryer according to claim 2, wherein the first mounting section (24) is provided with a first mounting hole (25), in which the first flexible damping component (101) is placed, the first flexible damping component (101) is sleeve-shaped and is fitted over the first mounting post (11), the second mounting section (62) is provided with a second mounting hole (63), in which the second flexible damping component (102) is placed, the second flexible damping component (102) is sleeve-shaped and is fitted over the second mounting post (12).

5. The motor vibration damping structure for the blow dryer according to claim 4, comprising screws, the screws pass sequentially through the first mounting section (24), the first flexible damping component (101), and are threaded into the first mounting post (11).

6. The motor vibration damping structure for the blow dryer according to claim 4, comprising screws, the screws pass sequentially through the second mounting section (62), the second flexible damping component (102), and are threaded into the second mounting post (12).

7. The motor vibration damping structure for the blow dryer according to claim 4, wherein both the first flexible damping component (101) and the second flexible damping component (102) are made of silicone.

8. The motor vibration damping structure for the blow dryer according to claim 2, wherein the motor chamber (2) is provided with a first intake port (21) and a first exhaust port (22), and the first intake port (21) is positioned opposite to the first exhaust port (22), the front end of the motor (3) is sleeved with a first flexible damping sleeve (4), and the rear end of the motor (3) is sleeved with a second flexible damping sleeve (5), the first flexible damping sleeve (4) and the second flexible damping sleeve (5) are both in contact with the inner wall of the motor chamber (2), the first flexible damping sleeve (4) has a front clearance hole (41), which is aligned with the first exhaust port (22), the second flexible damping sleeve (5) has a rear clearance hole (51), which is aligned with the first intake port (21).

9. The motor vibration damping structure for the blow dryer according to claim 8, wherein the first flexible damping sleeve (4) extends from the front end of the motor (3) towards the central part of the motor (3), and the second flexible damping sleeve (5) extends from the rear end of the motor (3) towards the central part of the motor (3).

10. The motor vibration damping structure for the blow dryer according to claim 8, wherein the first flexible damping sleeve (4) comprises an inner sleeve (42) and an outer sleeve (43), with the inner sleeve (42) being fitted over the front end of the motor (3), the front end of the inner sleeve (42) forms the front clearance hole (41), and an installation groove (44) is arranged between the inner sleeve (42) and the outer sleeve (43), the first flexible damping sleeve (4) is fitted over the sidewall of the first exhaust port (22) via its installation groove (44).

11. The motor vibration damping structure for the blow dryer according to claim 10, wherein the first flexible damping sleeve (4) further includes a connecting portion (45), and the connecting portion (45) connects the inner sleeve (42) and the outer sleeve (43), forming the bottom wall of the installation groove (44), the heating chamber (6) presses the connecting portion (45) tightly against the sidewall of the first exhaust port (22).

12. The motor vibration damping structure for the blow dryer according to claim 11, wherein the heating chamber (6) is provided with a heating element (7), and the heating chamber (6) has a second exhaust port (61), the first exhaust port (22) of the motor chamber (2) is connected to the second exhaust port (61) through the heating chamber (6).

13. The motor vibration damping structure for the blow dryer according to claim 8, wherein the rear end of the motor chamber (2) extends outward towards the center to form a damping stop plate (23), the first intake port (21) is provided on the damping stop plate (23), and correspondingly, the rear end of the second flexible damping sleeve (5) extends between the damping stop plate (23) and the rear end of the motor (3) to form a damping portion (52), the rear clearance hole (51) is located on the damping portion (52).

14. The motor vibration damping structure for the blow dryer according to claim 13, wherein the rear end of the motor chamber (2) extends into a circuit board chamber (8), within which a circuit board (9) is arranged. The rear end of the circuit board chamber (8) is provided with a second intake port (81), which communicates through the circuit board chamber (8) with the first intake port (21) of the motor chamber (2).

15. The motor vibration damping structure for the blow dryer according to claim 1, characterized in that the motor (3) is a brushless motor.

16. A blow dryer, comprising the motor vibration damping structure for the blow dryer as described in claim 1.
